(19) United States
(12) Patent Application Publication
(10) Pub. No.: US 2026/0285223 A1
(43) Pub. Date: Sep. 24, 2026

(54) Safety System Using Handheld Device

(71) Applicant: Polyoka Pile Inc., Towson, MD (US)

(72) Inventors: Corey James Polyoka, Towson, MD (US); Scott Thomas Polyoka, Cockeysville, MD (US)

(21) Appl. No.: 19/534,666

(22) Filed: Feb. 9, 2026

Related U.S. Application Data
(60) Provisional application No. 63/756,176, filed on Feb. 9, 2025.

(51) Int. Cl. B60Q 1/50

(52) U.S. Cl. CPC B60Q 1/544

(57) ABSTRACT

The invention of the present disclosure is that of a system that connects, e.g., via short wave radio waves or an integrated cable, monitoring software utilizing an accelerometer, gyroscope, proximity sensor, ambient light sensors, or combinations thereof, in mobile phones, to a physical signal light (either installed or an additional program on existing indicator lights) on the cars, trucks, trailers of other moving vehicles. The physical signal light illuminates a specific color when a connected phone is sensed to be in handheld use while in motion, indicating the operator of the vehicle is in a distracted state.

### CROSS REFERENCE TO RELATED APPLICATIONS

This application claims the benefit of priority of U.S. Provisional App. Ser. No. 63/756,176, the contents of which are hereby incorporated by reference in their entirety.

### BACKGROUND OF THE INVENTION

The present invention relates generally to driver safety on the roadways, and more specifically, to the detection of other drivers who are actively using handheld devices while driving.

The National Safety Council estimates that 1.6 million motor vehicle accidents each year are caused by cell phone use while driving. This is about 25% of all car accidents in the United States. In other words, cell phone use while driving increases the risk of an accident by four times. Prevention is needed. It is an object of the invention to reduce this risk using currently available technologies and combining them in a unique way to achieve this goal.

### SUMMARY OF THE INVENTION

The invention of the present disclosure is that of a system that connects, e.g., via short wave radio waves or an integrated cable, monitoring software utilizing an accelerometer, gyroscope, proximity sensor, ambient light sensors, or combinations thereof, in mobile phones, to a physical signal light (either installed or an additional program on existing indicator lights) on the cars, trucks, trailers of other moving vehicles. The physical signal light illuminates a specific color when a connected phone is sensed to be in handheld use while in motion, indicating the operator of the vehicle is in a distracted state.

Existing art does not link a handheld device in use in a vehicle to notify other drivers that a driver is distracted. A system of the present disclosure enables proactive defensive driving to prevent accidents. The use of the existing sensors in the phone paired to the signal light for this purpose has not been disclosed before, in this direct and simplified interaction. The technology is specific to phone use and advanced signaling for vehicles in motion.

### BRIEF DESCRIPTION OF THE DRAWINGS

FIG. 1 illustrates a system according to an embodiment of the present invention, including data flow between components.

FIG. 2 illustrates a vehicle equipped with a system of the present disclosure following a distracted driver using a mobile phone while driving.

FIG. 3 illustrates a vehicle equipped with a system according to the present disclosure and its operator.

FIG. 4 is a flow diagram illustrating interactions between various components of the present invention.

FIG. 5 illustrates the flow of input data through an exemplary application of the present disclosure to a wireless transmitter, then to a rear facing mounted beacon according to one embodiment of the present invention.

FIG. 6 illustrates a system of the present disclosure in various states.

FIG. 7 illustrates drivers following a vehicle driven by an operator actively using a mobile device while driving, taking defensive steps, the system also enabling law enforcement to intervene.

### DETAILED DESCRIPTION OF THE INVENTION

The invention of the present disclosure is that of an advanced signaling system that uses existing sensors in handheld mobile phones paired with a signal light (either additional or reprogrammed indicator lights) on cars, trucks, trailers and other moving vehicles that signals to other drivers on the road the driver is actively engaged with a handheld device and distracted.

A system according to the present disclosure would alert other drivers of a distraction, allowing for defensive driving and advanced decision making while approaching a distracted driver or seeing one in a rear-view mirror. Defensive driving and distracted driver avoidance can reduce traffic accidents, fatalities, injuries and property damage. It can be offered alongside safe driver programs with insurance companies, commercial fleet management and potential law and law enforcement.

Alongside the signaling, phone navigation applications already provide road information like traffic conditions, work zones, speed traps, stalled vehicles, objects in the road, etc. An application according to the present invention, besides the primary purpose of advanced signaling to nearby drivers, could link into these types of map notices, reporting the concentration of distracted drivers on roads.

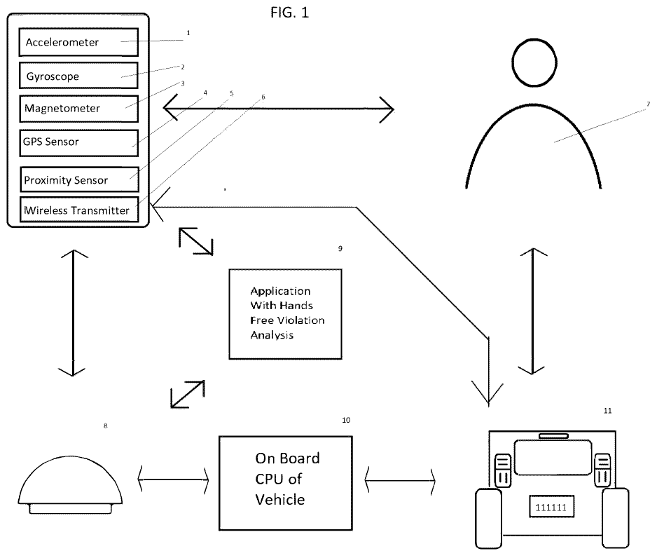

Referring to FIG. 1, an embodiment of the invention may include an accelerometer 1, a gyroscope 2, a magnetometer 3, a global positioning sensor (GPS) 4, a proximity sensor 5 and a wireless transmitter 6. A vehicle operator 7 will receive information compiled using these components and may do so using an application with hands free validation 9. A diagnostic port plug 8 in communication with the application having an analysis module 9 will also be in communication with an on board central processing unit (CPU) 10 installed in a vehicle 11.

On-phone sensors that provide input data to the analysis module of an application installed on a wireless phone via the wireless transmitter 6 may be transmitted to vehicle operator 7. An application downloaded onto a mobile phone may be used to analyze input from onboard sensors such as those mentioned above to determine if a nearby vehicle operator is engaged with a phone while driving, in which case the CPU is reprogrammed to illuminate the vehicle hazard lights.

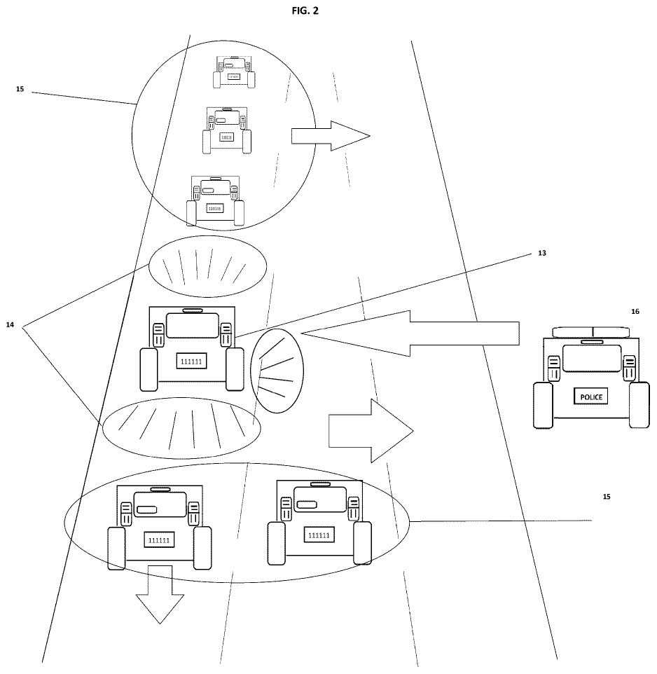

Turning now to FIG. 2, a vehicle enabled with a system of the present disclosure 13 will illuminate hazard lights when a vehicle operator is engaged with a mobile device. Vehicle onboard lights 14 that are front, side and rear facing will illuminate when vehicle operator is not compliant (i.e., using a mobile device while driving. Vehicle operators following the non-compliant driver 15 may then respond by driving defensively. Law enforcement 16 may also respond when the beacons are illuminated.

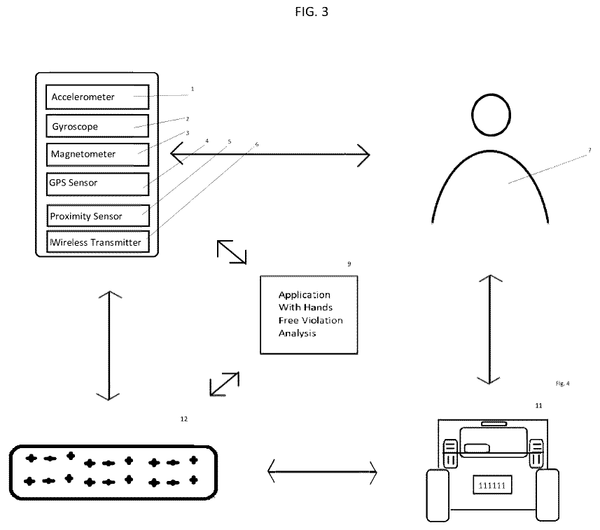

FIG. 3 illustrates a system as in FIG. 1, having an additional device 12 which may include a harness, independent power source, wireless transmitter, onboard processor and light emitting diodes (LEDs).

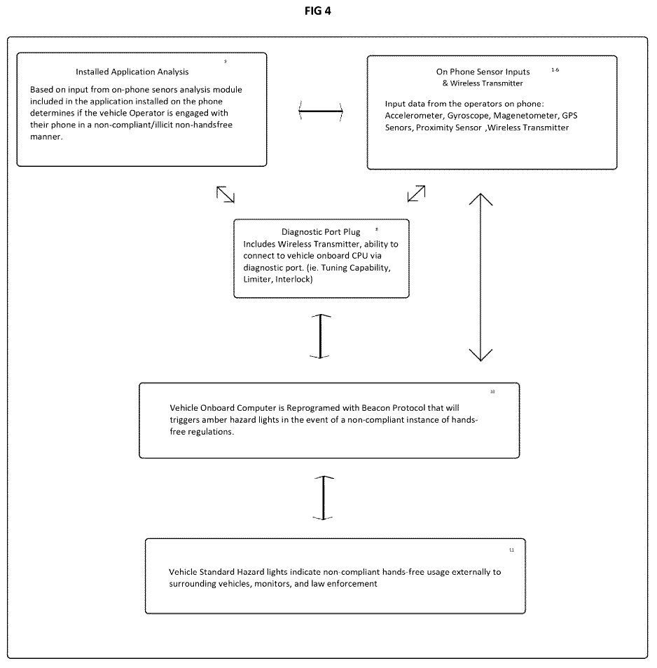

FIG. 4 is a flow diagram indicating a process flow of a system according to the present disclosure. Sensors installed in communication with analysis module 9 indicate when the vehicle operator is engaged in driving in a non-handsfree manner. A wireless transmitter in the vehicle's diagnostic port plug 8 connects with onboard CPU 10 and provides additional tuning capability. The vehicle's onboard computer is then reprogrammed to trigger a protocol that triggers the vehicle's hazard lights if the operator is non-compliant. The hazard lights indicate non-hands-free usage by the operator of a mobile phone. The analysis module communicates via wireless transmitter 6 with a rear-facing mounted beacon 12, which includes a housing, internal CPU with wireless transmitter, LED lights, independent power source and mounting or docking mechanism, either internal or external.

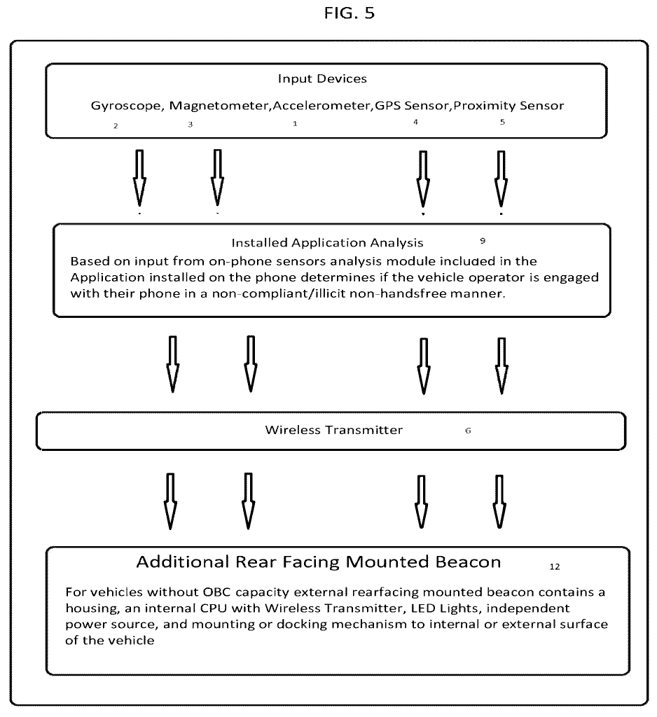

FIG. 5 illustrates another version of a process flow according to the present disclosure, wherein the system's input devices communicate directly with an installed application analysis module 9, which determines whether a vehicle operator is non-compliant.

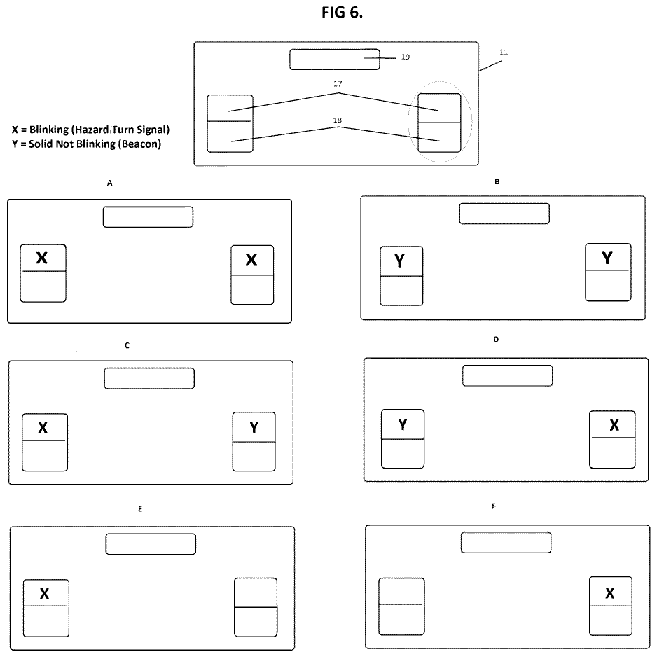

Turning now to FIG. 6, a vehicle 11 operated by an individual with a phone present in the vehicle and connected to the vehicle via wireless transmitter will activate amber colored turn signals 17, red brake lights 18 or a third brake light 19 above the rear view window. When solid amber lights are blinking (A), the system of the present invention is not enabled. When they are not blinking, the system is enabled (B). Alternatively, a blinking right turn signal (C) may indicate enablement, while a blinking left turn signal (E) may indicate the system is not enabled. Similarly, a blinking right turn signal (F) may indicate the system is not enabled.

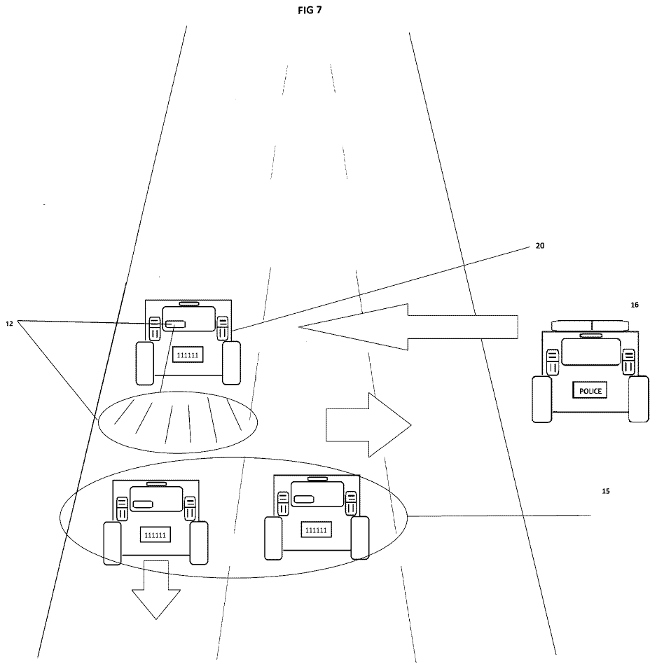

Turning to FIG. 7, in the case of a vehicle with a rear facing hardware light 20 that can illuminate, the light illuminates during non-compliant driving. This enables vehicle operators following the non-compliant driver 15 may exercise appropriate caution. Law enforcement may then observe the illuminated light 12 and take appropriate action.

It will be clear from this disclosure that the safety benefits of the systems described herein are designed to alert drivers of nearby drivers to persons engaging in unsafe driving while using a mobile device so they may exercise appropriate caution, and law enforcement may be alerted to unsafe driving of this nature, which is illegal in many states. These and other benefits of the present invention will be understood by those of ordinary skill in the art.

What is claimed is:

1. A vehicle safety system for alerting vehicle operators when a nearby operator is driving while using a mobile device in an unsafe way, the system comprising:
one or more sensors selected from the group consisting of an accelerometer, a gyroscope, a magnetometer, a global positioning sensor (GPS), a proximity sensor, installed on a mobile device and in wireless communication with a wireless transmitter;
an application installed on said mobile device and comprising an analysis module, wherein said analysis module is configured to determine whether a vehicle operator is driving while using said mobile device in a non-handsfree manner;
at least one light source in communication with said analysis module and a central processing unit (CPU) installed in a vehicle, wherein when an operator of the vehicle is driving and using a device in a non-handsfree manner, said light source is illuminated to alert nearby vehicles, prompting them to exercise caution.

2. The vehicle safety system of claim 1, wherein the at least one light source emits light from a location at the front, side or rear of said vehicle.

3. The vehicle safety system of claim 1, wherein the at least one light source comprises a light emitting diode (LED).
